(19) United States
(12) Patent Application Publication
(10) Pub. No.: US 2008/0275794 A1
(43) Pub. Date: Nov. 6, 2008

(54) Virtual real estate office

(75) Inventors: Frank B. Ioimo, Corona, CA (US); Emma E. Aguirre, Riverside, CA (US)

Correspondence Address: BUHLER ASSOCIATES;BUHLER, KIRK A., 1101 CALIFORNIA AVE., SUITE 208, CORONA, CA, 92881, US

(73) Assignee: EMMA E. AGUIRRE

(21) Appl. No.: 11/900,512

(22) Filed: Sep. 13, 2007

Related U.S. Application Data
(60) Provisional application No. 60/927,695, filed on May 3, 2007.

(51) Int. Cl. G06Q 30/00

(52) U.S. Cl. 705/27; 705/14

(57) ABSTRACT

Virtual Real Estate Office is to Real Estate and home loans what the assembly line is to automobiles. This patent improves an existing process.” [i.e.] Henry Ford invented a streamlined automobile assembly line to improve an existing process. This process was the assembling of automobiles.

The Virtual Real Estate Office is designed to streamline the assembling of Real Estate and mortgage processes and transactions.

The “VRO” is an on-line version of an actual Real Estate and or mortgage office, where Real Estate Agents and loan officers can interact with each other and or their clients, potential clients and all vendors services used to perform the completion of a compliant Real Estate and or mortgage transaction.

These vendors include but are not limited to the following; escrow, title, appraisal, termite, companies as well as credit reporting agencies, office staff, loan processors, etc.

### CROSS REFERENCE TO RELATED APPLICATION

This application claims the benefit of Provisional 60/927,695 filed May 3, 2007 the entire contents of which is hereby expressly incorporated by reference herein.

### FIELD OF THE INVENTION

This invention relates to improvements, systems and infrastructures with the interfacing of all functions of real estate & mortgage brokerages, real estate professionals, and the consumer. Said systems serve as a “Virtual Real Estate Office” enhancing the administration, interaction and information exchange with the broker, affiliated real estate professionals and consumers.

More particularly, the present partially working model known as the “VRO” or “Virtual Real Estate Office” in which will enact as an intellectual hub that will be utilized on both a front and back end system using Intra/Internet functions as a conduit to connect and retrieve vital relevant business information on demand as needed.

The VRO will serve as the master panel connecting various specified sub panel modules Known as the “VOM” “Virtual Office Manager”, the “VTC” “Virtual Transaction Coordinator”, “VEO” Virtual Escrow Office” “VLM” “Virtual Loan Manager” and “VTO” “Virtual Title Office” and the “VI” Virtual Interview which will be utilized as a recruiting function and as a video/DVD technology based introduction of the benefits the company offers to real estate professionals.

The Virtual Real Estate Office will support other utility functions know as “Hubs” to aid in the facilitation of real estate, mortgage, and escrow transaction, marketing, training, and networking with other affiliated real estate professionals. Such utilities are known as Transaction, Marketing, Training and Networking hubs.

### BACKGROUND OF THE INVENTION

Many functions of the “VRO” are created by intellectual design and should be considered intellectual property such as web sites, Intranet/Internet search boxes, link exchanges, management, functions, messaging boards, instant messaging, inventory activity and status hosted on pre-designated servers. In addition, portions of the sub panels will employ other purchased licensed systems used to serve as compliant functions as well as convenience and simplification. Another problem with operating a real estate office is the overhead of the office space that must be sufficiently sized to support the sales and management staff.

U.S. Pat. No. 6,968,513 issued Nov. 22, 2005 to Walter A Rinebold et al., discloses an on-line localized business referral system and revenue generation system. This system allow for a connection of customers with business in the area but does not provide for a connection of home sellers with realtors, lending institutions and other services needed by a home purchaser.

U.S. Pat. No. 6,430,542 issued Aug. 6, 2002 to William J. Moran discloses a computer implemented program for financial planning and advice system. This system provides budgeting and planning advice for a person to determine how to plan their financing. One form of financial advice includes home or realty. While this program aids a person in handling their finances it does not aid in home finding or financing.

Published U.S. Patent Application 2002/0052814 that was published May 2, 2002 to Robert M. Ketterer discloses a Virtual real estate brokerage system. This system deals with the basic transaction of buying or selling realty but does not include recruiting for sales people, home inspection, home repair or the large number of services that a home owner might need to prepare their home for a sale or to repair a home that they purchased.

U.S. Pat. No. 6,594,633 issued Jul. 15, 2003 to Vincent S. Broerman discloses a real estate computer network that connects buyers, broker, sellers and financial institutions. This system is similar to the multiple listing services (MLS) that is used by most realtors but does not include recruiting for sales people, home inspection, home repair or the large number of services that a home owner might need to prepare their home for a sale or to repair a home that they purchased.

U.S. Pat. No. 7,152,037 issued Dec. 19, 2006 to Jeffrey C. Smith discloses a system, method and computer program product for facilitating real estate transactions. This patent specifically addresses the real estate transaction and does not address the additional functions that are outside of the direct buying and selling of property. These additional functions include home inspections, repairs and employee recruiting/hiring.

The “VRO” should be known as the core component and gateway connecting all functions of daily operations of a fully compliant real estate and mortgage office combined, including but not limited to the affiliated real estate professional and consumer, but as in a virtual status accessible anywhere an Internet connection is available.

### BRIEF SUMMARY OF THE INVENTION

It is an object of the virtual real estate office to provide administration and full service of the real estate and mortgage office offering professionals the ability to service consumer requests, access required documents/disclosures.

It is another object of the virtual real estate office to provide enhancement of access of desired business related information and documents on demand to simplify daily tasks in the most compliant form.

It is another object of the virtual real estate office to provide access to a consumer that contains relevant and vital information performed by the real estate professional regarding the desired information and proposed services in which they provide.

It is another object of the virtual real estate office to provide a connection with mortgage professionals to access and exchange relevant, or any information in which may enhance knowledge, compliance, and improved customer service.

It is still another object of the virtual real estate office to provide access to mortgage professionals, brokers, escrow, and title services and to management as well as interfaced interaction with consumers at any time, anywhere as long as an Internet connection is supported.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows the virtual administrator office panel.

FIG. 2 shows an interconnection diagram of the components of the virtual real estate office.

FIG. 3 shows the virtual mangers office panel.

FIG. 4 shows the virtual research office panel.

FIG. 5 shows the virtual escrow office panel.

FIG. 6 shows the virtual marketing department panel.

FIG. 7 shows the virtual networking panel.

FIG. 8 shows the virtual loan officer panel.

FIG. 9 shows the virtual training room panel.

FIG. 10 shows the virtual transaction coordinator panel.

FIG. 11 shows the virtual title office panel.

FIG. 12 shows the virtual agent conference room.

FIG. 13 shows a home page panel for an agent that is registered with the virtual real estate office.

FIG. 14 shows a virtual conference room panel.

FIG. 15 shows a flow chart for a typical mortgage process.

FIG. 16 shows a typical real estate listing page.

FIG. 17 shows a typical escrow process for a real estate transaction.

FIG. 18 shows a relationship of various features on the virtual real estate office.

FIG. 19 shows a flow chart of the saving viewing and retrieval of documents within the virtual realty office.

FIG. 20 shows three different types of users of the virtual realty office and the access that is available for each user.

FIG. 21 shows a table of access authorization for users of the virtual real estate office.

FIG. 22 shows a sample integration of the VTO in one contemplated embodiment.

### DETAILED DESCRIPTION

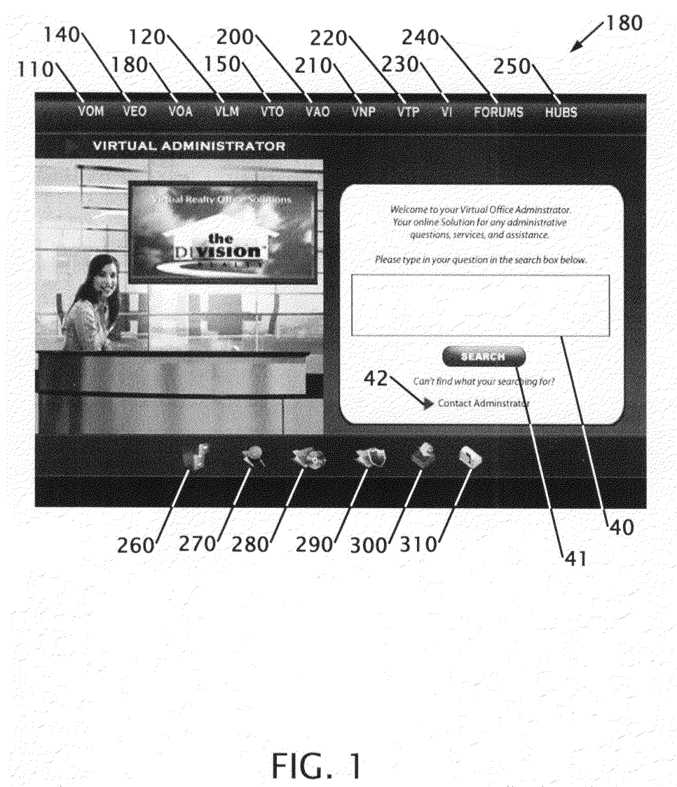

FIG. 1 shows the virtual administrator office panel 180. This panel will serve as an online office manager. Within this Reception Area, Consumers may directly access a variety of features that are each delivered in the Conference Room; Division Realty staff and Hybrid Agents precede directly to the appropriate my desk configuration, based on a successful login and associated user attributes. The top of this panel provides quick access to various modules of the virtual real estate office. Some or all of these options may not be visible or available based upon the access privileges of a user. The access links along the top of the page include but are not limited to a virtual office manager (VOM) 110. The virtual office manager 110 is where agents and others may interface with the broker. A link to a virtual escrow office 110 (VEO) is shown where agents, brokers, and others may interface with the escrow officer. The virtual office administrator (VOA) 180 is shown where agents, brokers, and others may interface with the appraiser. The virtual loan manager (VLM) 120 is shown where agents, brokers, and others may interface with the loan manager. The virtual title officer (VTO) 150 is shown where agents, brokers, and others may interface with the title officer. The virtual appraisal officer (VAO) 200 is shown where agents, brokers, and others may interface with the appraisal officer. The virtual networking panel (VNP) 220 provides a central place to select vendors and contractors. The virtual interview (VI) 230 provides a conduit for potential employees to submit resume's and have an interview.

In the virtual interview a candidate can view open jobs that are available and can apply for specific jobs, or can upload a resume into the system for listed jobs or to have the resume on file for future openings. The candidate can be presented with a series of questions based upon the position to explain their qualifications in a virtual environment where the system operates like a person conducting an interview to filter candidates. It is contemplated that the virtual interview includes provisions for recording and saving voice and visual records from the interview. A blank recruiting form is available for a candidate to enter particulars such as but not limited to name, date, education, work experience and salary. Within the interview, training and recruiting of candidates is performed. The training includes videos of the procedures and steps used to process a real estate transaction within the virtual realty office. The forums 240 provides where agents, clients, brokers and other may exchange information. If the user has not completed the required virtual realty office orientation, they may be blocked from using this feature. The hubs 250 provides access to various research, training, services and marketing hubs

The left side of this panel provides an image that is a quick visual reference that is associated with the services for the panel. In this figure the image is a person at a front desk that provides the appearance of what a client might see when they enter a realty office. The right center portion of the screen allows a person to enter a question in the same manner that a person may ask a receptionist a question in the physical world. Artificial intelligence may be incorporated to determine the question being asked and provide an appropriate response. It is also contemplated that voice recognition or speech syntheses can be used to perform the communication as if talking to a physical person. If a question is entered into the box 40 and the search button 41 is selected the virtual realty office will search for one or more responses. If a person wants to go directly to a physical person they can select the contact administrator 42 to go directly to a physical person or an automated response.

Along the bottom edge of the panel an additional number of links are available. These links include, but are not limited to. A filing cabinet 260 where client records are stored. A search tool 270 that allows a person to perform more advanced searches. Stores record, and data as well as the ability to store or save the files a person is currently working with 280. Security and virus scanning and protection to ensure the data being stored are secure. Research information 300 allows access to a library of public domain information, files and records. Voice mail, email and similar means of communication 310. Other panels have similar links and the unique information that is associated with each panel will be described in more detail herein.

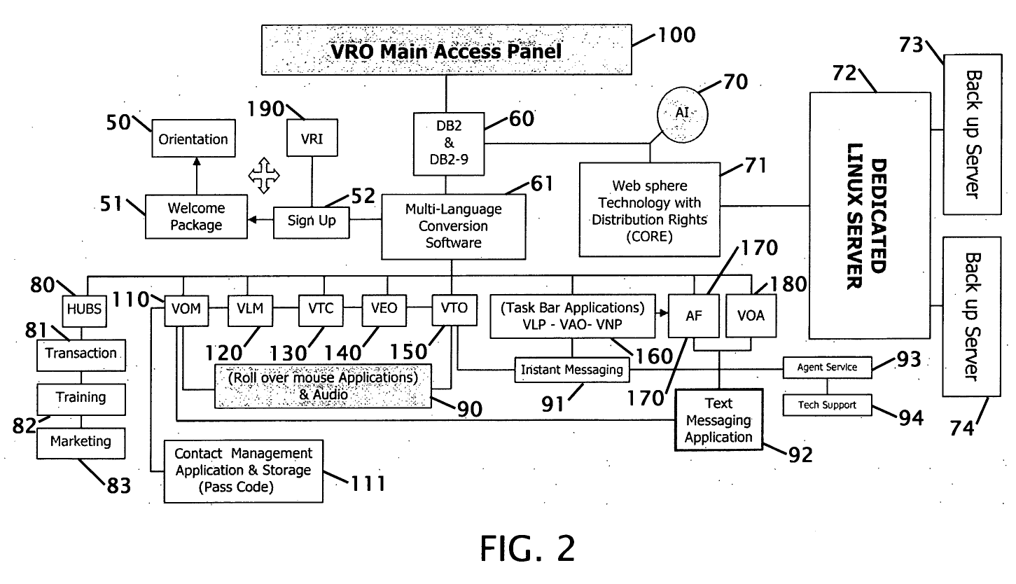

FIG. 2 shows an interconnection diagram of the components of the virtual realty office. The VRO mail access panel 100 is the initial starting panel that a user views when the user enters the web site. The BD2 & DB2-9 60 represents the database that is being used for the virtual realty office 100. Multi-language conversion software 61 converts and exchange information or data between users that communicate in different languages. In the preferred embodiment the default language is English, but it is contemplated that use's with different languages can communicate through the language converter 61 using their native language. Within the web site a user can sign up 52 using the virtual recruiting interview 190. Once a user signs up 52 they will receive a welcome package 51 that will authorize them to receive an orientation 50 for on line or a mailed package of orientation information.

Artificial intelligence (AI) 70 is used to correct minimal errors and aid users that are unfamiliar with the web site. The software includes a Web sphere technology with distribution rights (CORE) 71 that protects the software from copying and illegal distribution. The entire website and software operates within a dedicated Linux server 72. While the preferred embodiment is disclosed with a Linux server 72 other servers are contemplated that will provide equivalent operation. Redundant back-up servers 73 and 74 are shown to ensure safe operation of the Virtual Realty Office.

Once a user is logged into and authorized to use the virtual realty office they have access to the virtual title office (VTO) 150, virtual escrow (VEO) 140, virtual title office (VTO) 130, virtual loan manager (VLM) 120 and virtual office manager (VOM) 110. These virtual managers, offices and panels 110, 120, 130, 140 and 150 are described in more detail with their respective panels. It is contemplated that when a user rolls the mouse or cursor over these access options 90 the system will show a thumbnail of the panel and or provides an audio byte of the panel. The panels allow contact management application & storage with a pass code 111. In addition to access to the panels the user has access to information hubs 80 that include but are not limited to translation 81, training 82 and marketing 83. More detail of the hubs is described with the respective hubs herein.

An instant messaging system 91 provides saving and retrieving of messages such as voice mail, email, text 92, picture mail and video. The messaging allows a user to leave a message for one person, a group of people or all of the users. A series of task bar application are available to the user including but not limited to a virtual loan processor, a virtual appraisal officer and a virtual networking panel 160. These task bar application are shown and described with their respective application herein. The task bar applications 160 link to an agent form (AF) 170. Under most conditions the user can exchange information and ask questions to a virtual office administrator (VOA) 180. Agent service 93 and tech support 94 are available to users to request support and exchange information.

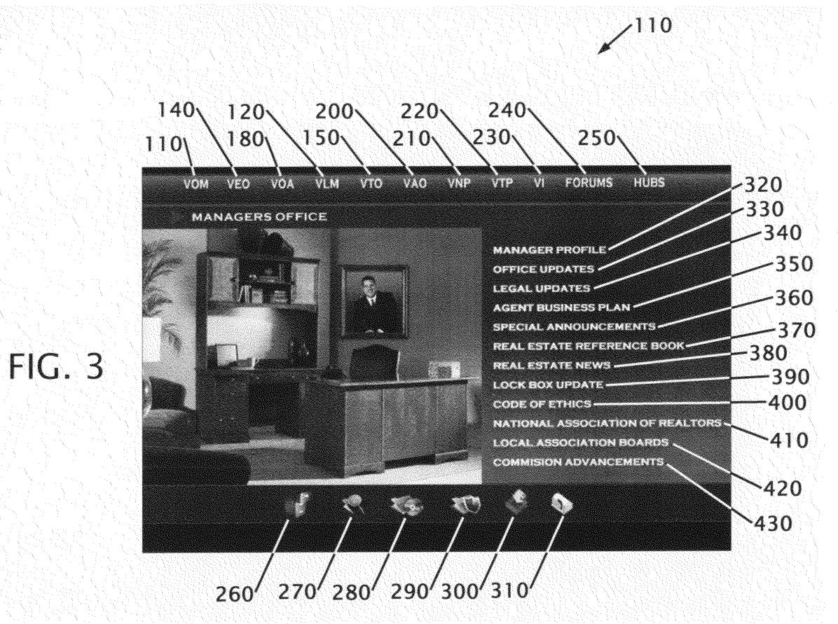

FIG. 3 shows the virtual mangers office panel 110. The selectable options along the top and the bottom of this panel are described in more detail with FIG. 1 and with their respective links herein. The virtual manager's office provides access to a number of functions and data that a manager may use. The broker works from a tailored my desk area; however, other brokerage staff needs to interface with the broker and receive their work products. The virtual office manager area is where agents and others may interface with the Broker. It is contemplated that a user can open drawers and view files by moving the cursor over the item and clicking to open or view the contents. The manager profile 320 may include all data fields and elements provided by their VRO level (Gold, Silver, and Bronze) or may be performed by either the broker or the overall VRO administrator. The picture of the manager on the wall can be changed to match the person's office. Office update 330 allows a manager to update their company's service and contact information, including a link to their company's web site. Legal update 340 allows a manager to view and update links to legal document. Agent business plan 350 allows a manager to view track and make changes to their business plan as well as the business plans of others and the brokerage. A special announcement 360 allows a manager to view, add, change and update any special announcements regarding listings or the realty office. Real estate reference books 370 that provide an on line reference to these books. Real estate news 380 that provides an on line link to current and historical real estate news. The Lock box update 390 allows a manager to view, change and update the lock boxes one their properties. The Code of ethics 400 provides an on line link to this resource that many additionally include local information. The National Association of realtors 410 is an on line link to the national association where a user can view information regarding themselves and other listed agents. The Local association board 420 provides an on line link to local realty boards where an agent can view information that is tailored to their local area. The commission advancements 430 allow a manager to view any and all advancements on commission for themselves and agents they manage. In the description the word manager and agent is user interchangeably, while most of the formation is common between managers and agent's different levels of authority are contemplated to limit access to agents while granting access to managers that have one or more agents working for them.

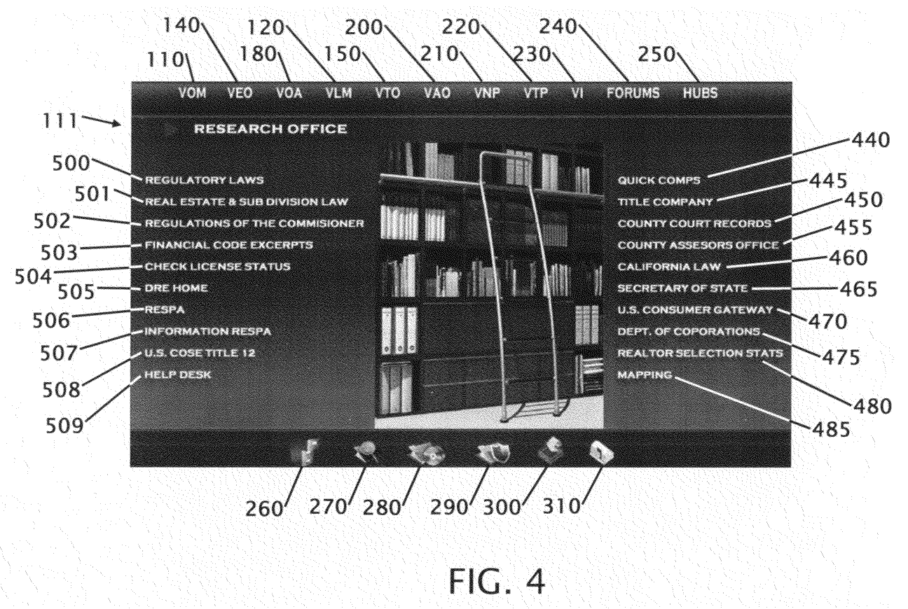

FIG. 4 shows the virtual research office panel 111. The selectable options along the top and the bottom of this panel are described in more detail with FIG. 1 and with their respective links herein. The research office provides access to on line books, documents, regulations, maps and other information. These links include but are not limited to quick comps 440 that allows a realtor to find similar listings and realty that has been sold. Title company 445 to research and prepare title documents. County court records 450, county assessors office 455, California law 460, Secretary of state 465, U.S. consumer gateway 470, department of corporations 475, realtor selection statistics 480 mapping 485, regulatory laws 500, real estate & sub division law 501, regulations of the commissioner 502, financial code excerpts 503, check license status 504 of realtors and contractors, DRE home 505, Respa 506, Information Respa 507, U.S. Code Title 12 508 and to link to a help desk 509 to receive advice and additional information.

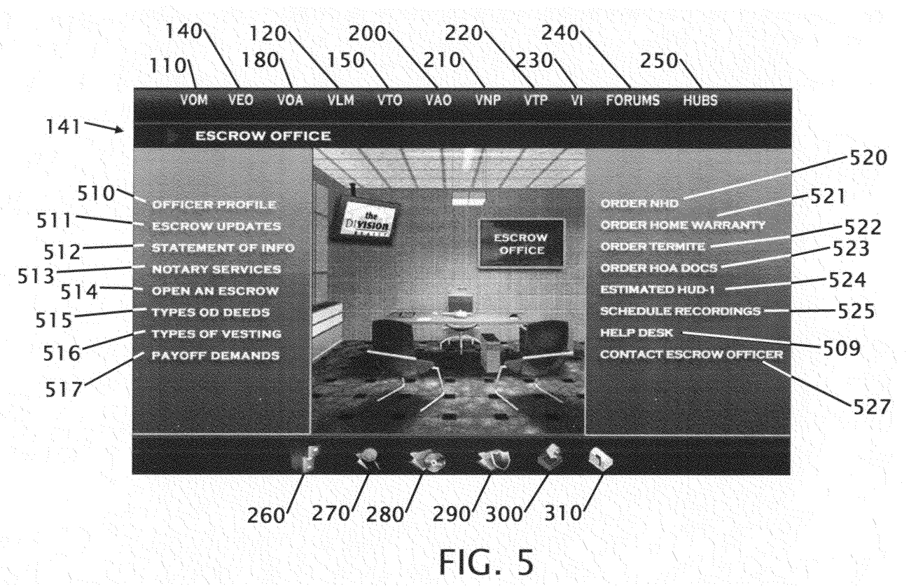

FIG. 5 shows the virtual escrow office panel 141. The selectable options along the top and the bottom of this panel are described in more detail with FIG. 1 and with their respective links herein. This panel will serve as an online escrow office. The mid section may contain an area to submit any related coordinating related question that may be entered into the search box for Intranet/Internet search and retrieval. The option to email or instant message the escrow officer is available if and when necessary. This panel; may contain the escrow officer profile with photo. The option remains to order escrow services and or contact the escrow officer if the subject matter is not satisfactory, available, or comprehendible.

From this escrow office panel options are available to an escrow officer that includes but is not limited to office update 510, escrow updates 511, statement of information 512, notary services 513, open an escrow 514, types of deeds 515, types of vesting 516, payoff demands 517, order NHD 520, order home warranty 521, order termite 522, order HOA documents 523, estimate HUD-1 524, schedule recordings 525, help desk 509 and contact escrow officer 527.

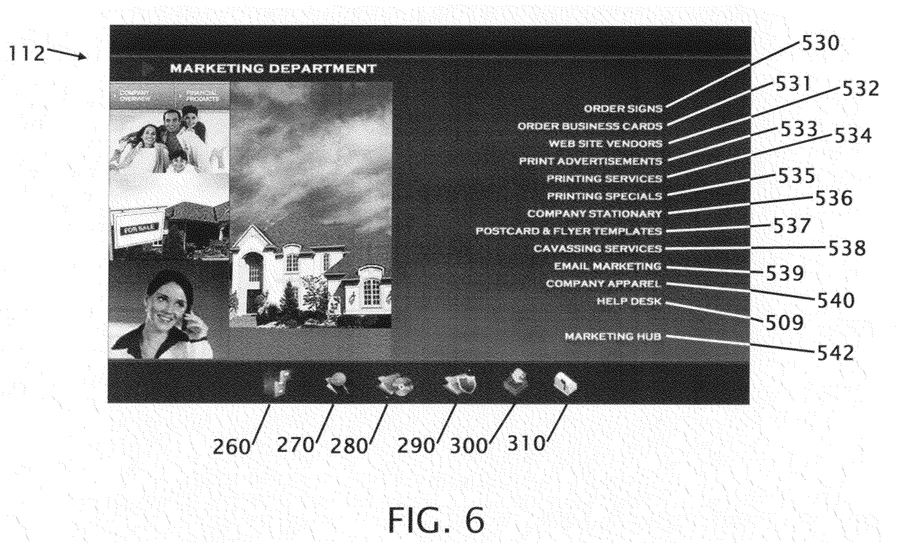

FIG. 6 shows the virtual marketing department panel 112 provides a central access point for marketing services and information. The selectable options along the top and the bottom of this panel are described in more detail with FIG. 1 and with their respective links herein. This panel gives access to the following links including but not limited to order signs 530, order business cards 531, Web site vendors 532, print advertisements 533, printing services 534, printing specials 535, company stationary 536, postcard & flyer templates 537, Canvassing services 538, Email marketing 539, company apparel 540, help desk 509, marketing hub 542.

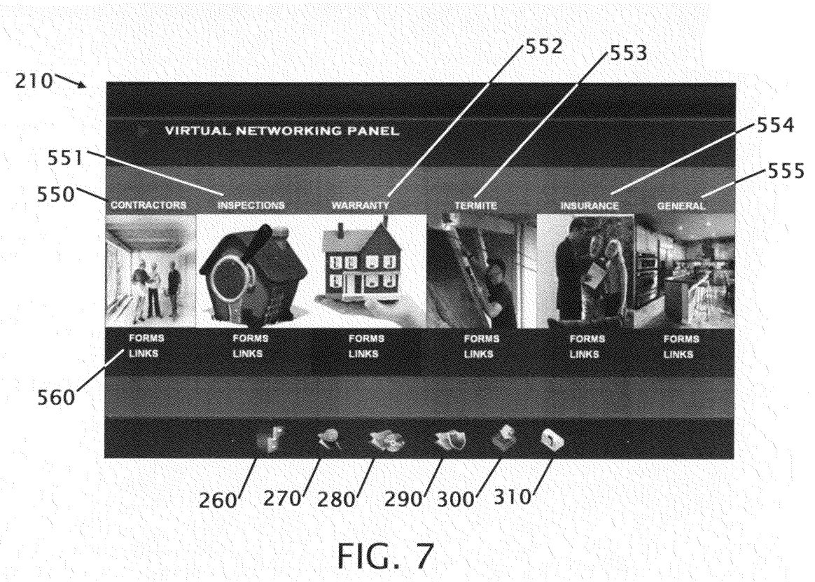

FIG. 7 shows the virtual networking panel 210. The selectable options along the top and the bottom of this panel are described in more detail with FIG. 1 and with their respective links herein. This panel will serve as an online networking center to emulate an online office environment and experience. In addition, included will be an area for combined office residential listing inventory. The mid section may contain an area to submit various messages with designated message boards. In addition navigation link that will connect to most commonly used communication and information links. In addition an area for instant messaging offering direct communication with anybody who is logged onto the system. This panel gives access to the following links including but not limited to contractors 550, inspectors/inspections 551, home warranty services 552, termite services 553, home and property insurance 554, general services 555, and links to standard and custom forms 560 for the offered services.

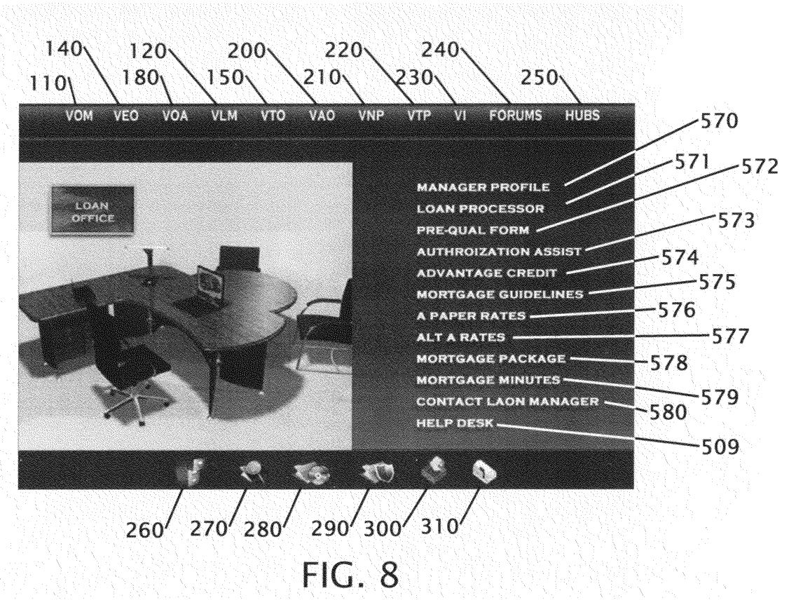

FIG. 8 shows the virtual loan officer panel. The selectable options along the top and the bottom of this panel are described in more detail with FIG. 1 and with their respective links herein. This panel will serve as an online loan office manager. The mid section may contain an area to submit any related real estate and or mortgage related question that may be entered into a search box for Intranet/Internet search and retrieval. The panel may optionally include loan office manager profile with photo. An option remains to set an appointment with the loan office manager if the subject matter is not satisfactory, available, or comprehendible. This panel gives access to the following links including but not limited to the manager profile 570, loan processor 571, a pre-qualification form 572, authorization assistant 573, advantage credit 574, mortgage guidelines 575, A paper rates 576, alternate A rates 577, mortgage package 578, mortgage minutes 579, contact a loan manager 580 and the help desk 509.

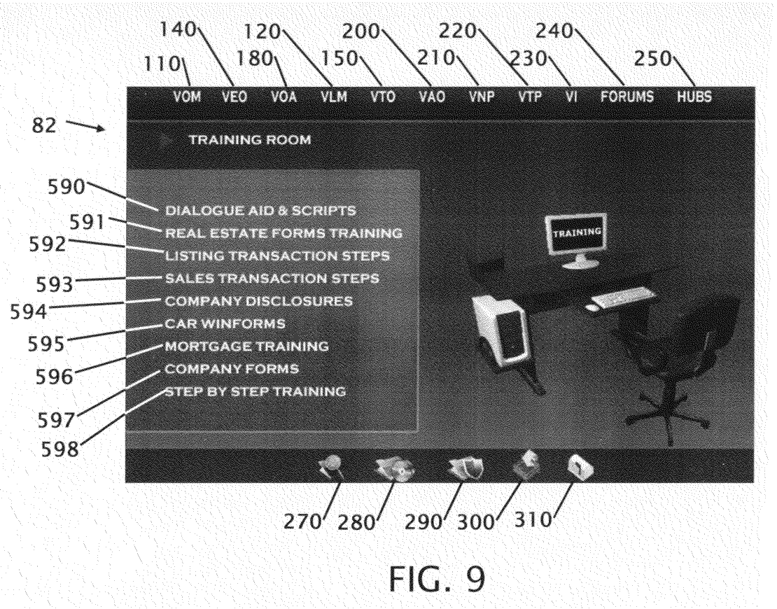

FIG. 9 shows the virtual training room 82 panel. The selectable options along the top and the bottom of this panel are described in more detail with FIG. 1 and with their respective links herein. This panel will serve as an online training center containing real estate and mortgage training at all levels. The mid section may contain an area to submit any related question that may be entered into the search box for Intranet/Internet search and retrieval of necessary related available training. This section will encompass contracts, disclosures, step by step on line training, dialogue aids and scripts, professional development, as well as other training modules. This panel gives access to the following links including but not limited to dialogue aid & scripts 590, real estate forms training 591, the listing transaction steps 592, sales transaction steps 593, company disclosures 594, car winforms 595, mortgage training 596, company forms 597 and step by step training for various company processes 598.

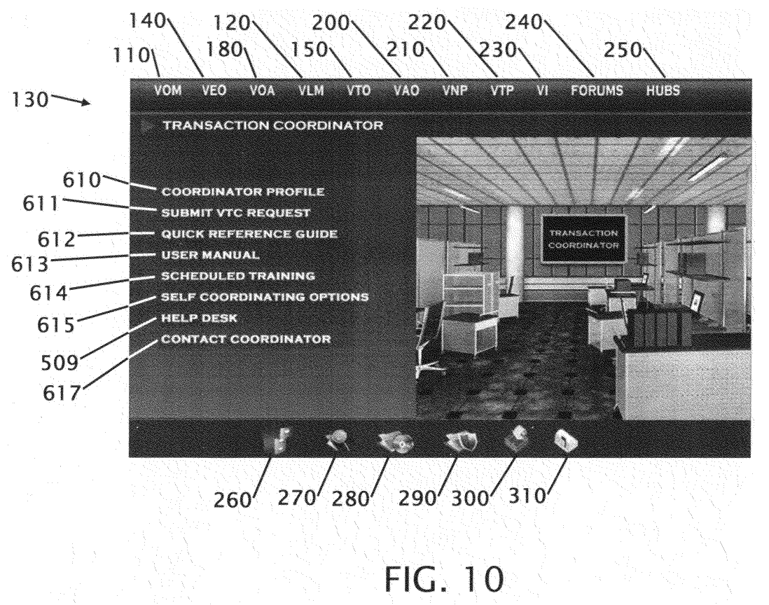

FIG. 10 shows the virtual transaction coordinator 130 panel. The selectable options along the top and the bottom of this panel are described in more detail with FIG. 1 and with their respective links herein. A picture of the transaction coordinator may be shown on the wall and can be changed to match the person's office. This panel gives access to the following links including but not limited to the coordinator profile 610, submitting VTC requests 611, quick reference guide 612, users manual 613, schedule training 614, self coordinating options 615, help desk 509, and for a user to contact the coordinator 617.

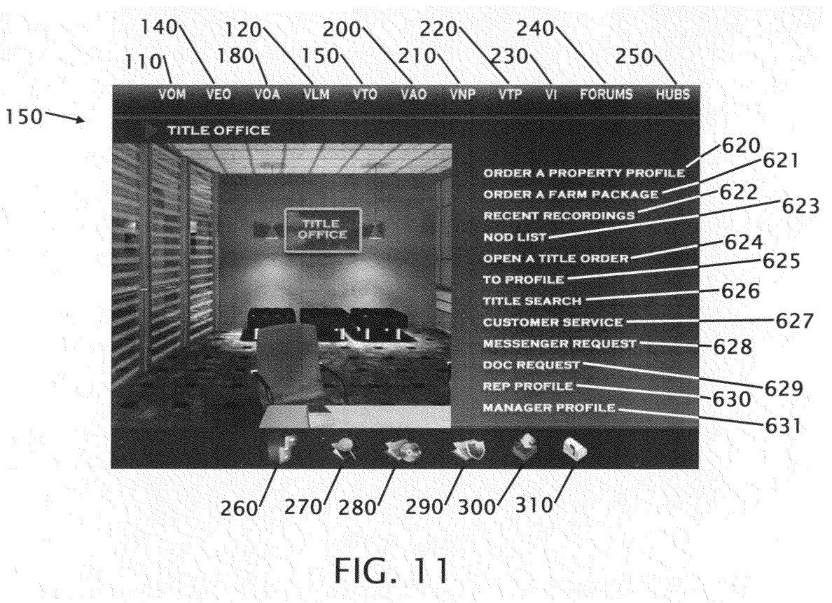

FIG. 11 shows the virtual title office 150 panel. The selectable options along the top and the bottom of this panel are described in more detail with FIG. 1 and with their respective links herein. This panel will serve as an online Virtual Title Office. This panel has links that will provide, open order requests, property information, document requests, messenger services, legal, and typical title related topics/news. The mid section may contain an area to submit any related title and or real estate related question that may be entered into the search box for Intranet/Internet search and retrieval. The option to email or instant message the loan manager is available if and when necessary. This panel may optionally show the title officer's profile with photo. The option remains to contact the title officer or representative if the subject matter is not satisfactory, available, or comprehendible. This panel gives access to the following links including but not limited to order a property profile 620, order a farm package 621, recent recordings 622, nod list 623, open a title order 624, to profile 625, title search 626, customer service 627, messenger request 628, document request 629, Rep profile 630 and manager profile 631.

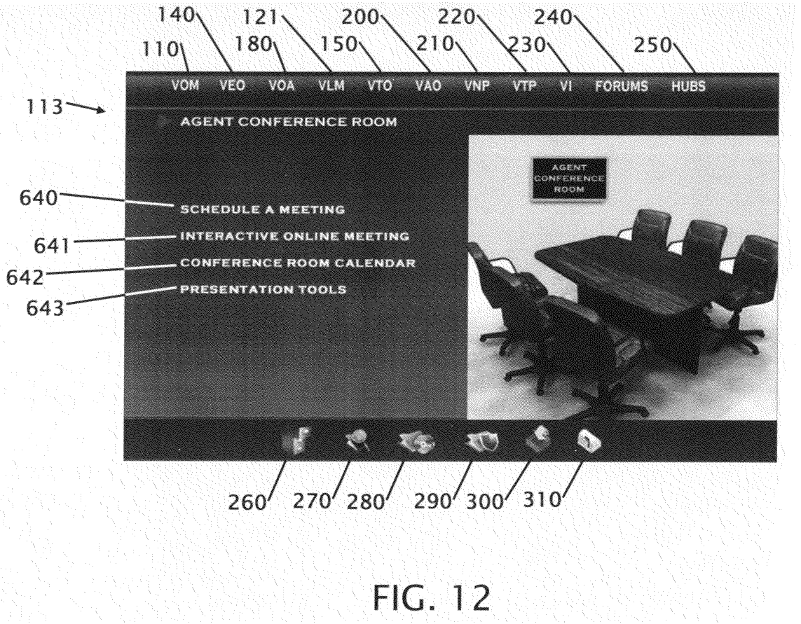

FIG. 12 shows the virtual agent conference room 113. The selectable options along the top and the bottom of this panel are described in more detail with FIG. 1 and with their respective links herein. The agent conference room 113 is a meeting room where multiple parties can meet at a pre-determined time to exchange information. Facilitates a real-time meeting. May include consumers, hybrid agents, division management, auditors, etc. Each participant is given a chair with an indication of which they are (photo, avatar, etc). Typed comments appear on the projection screen. If desired, an electronic/printable transcript of the conference will be available to each participant (typed comments only) at the end of the meeting. A calendar scheduling system provides information about scheduling a physical conference room available to the brokerage, with a calendar of previously scheduled dates/times.

It is also contemplated that the agent conference room 113 can be used as a Blog to exchange information, or add to an existing string of comments. This panel gives access to the following links including but not limited to scheduling a meeting 640, interactive online meeting 641, conference room calendar 642 and presentation tools 643. In one contemplated embodiment the chairs can be populated with virtual people that may have a live or saved facial image of each person at the table.

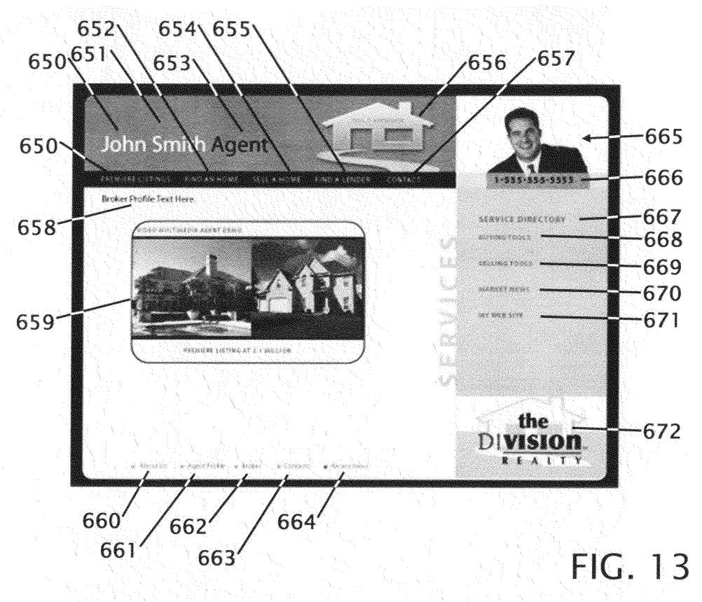

FIG. 13 shows a home page panel for an agent that is registered with the virtual real estate office. It is contemplated that the background, foreground, colors or images on this page can be altered to designate the level of authority within the virtual realty office or the amount of sales dollars achieved by the agent. It is contemplated that levels designated as silver, bronze and gold can be used. In the embodiment shown the home 656 is shown as gold to designate the level of sales for this agent. A picture of the agent 665 and the contact phone number 666 is shown in this panel to identify the agent along with the first 650 and last 651 name of the agent 653 and the title or status of the agent. While only and agent title is shown here title for all users of the virtual realty office are contemplated. The broker profile text 658 is shown on this screen to identify the training, skill, and type of sales this person deals with. A premiere listing of one or more houses 659 is shown on this page. The panel also shows the realty agency 672 the agent is working for. Quick links to the agents premiere listing 650, finding a home 652, selling a home 654, finding a lender 655 and to contact the agent 657 are available on this panel. The right side of this panel provides links the a service directory 667 where a user can access buying tools 668, selling tools 669, market news 670 and the agents web site 671. Along the bottom of this panel a user has links for information about the agent and the agency 660, the agent's profile 661 the broker 662, contacting the agent 663 and recent news 664. While a particular arrangement of this panel is shown with images and links other arrangements of the components are contemplated that provide similar functions.

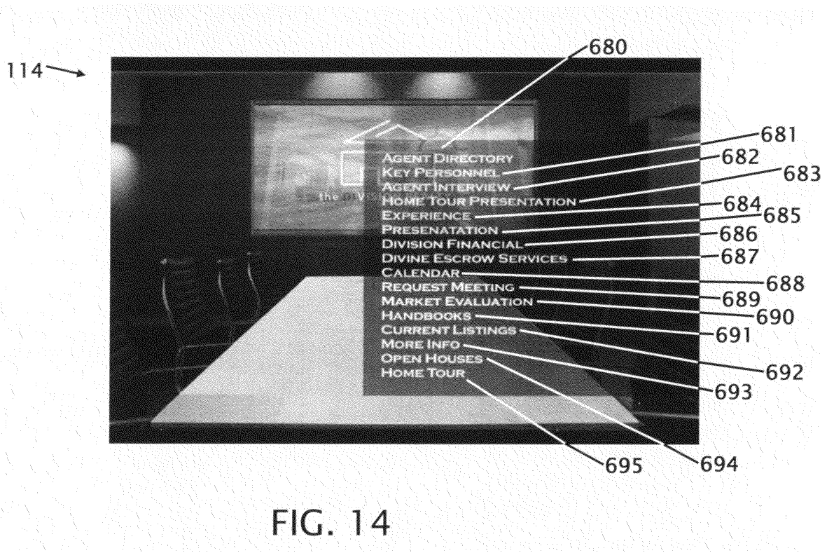

FIG. 14 shows a virtual conference room panel 114. This panel gives access to the following links including but not limited to an agent directory 680, key personnel 681, an agent interview 682, home tour presentation 683, experience 684, presentation 685, division financial 686, divine escrow services 687, a calendar 688, request for a meeting 689, market evaluation 690, handbooks 691, current listings 692, more information 693, open houses 694 and home tours 695. The calendar scheduling system provides information about scheduling a physical conference room available to the brokerage, with a calendar of previously scheduled dates/times.

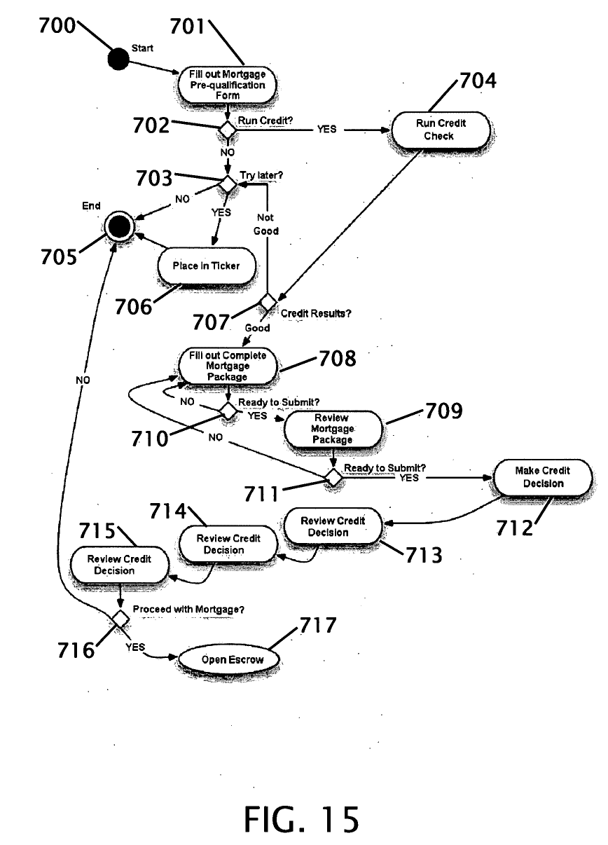

FIG. 15 shows a flow chart for a typical mortgage process. The process starts 700 when a client fills out the mortgage pre-qualification form 701. A decision is made if a credit check must be performed 702 If a credit check is required then a credit check is run 704 to determine if the person has good or bad credit to purchase the home. If a credit check is not run then the process ends 705. The results of the credit check 707 are evaluated. If the credit is not good they may decide to try again 703 or place the client in a ticker 706 to run the credit check at a future time.

If the credit is good then the client will fill out a complete mortgage package 708 and submit 710 the package for review of the mortgage package 709. If the package is complete and ready to submit 711 then it will be passed for a credit decision 712. If the package is not complete then it will be returned back to be filled out 708. The credit decision can and usually goes through a series of credit decisions 713, 714 and 715 where a decision is made to proceed with the mortgage 716 or to end the process 705. If a decision is made to proceed with the mortgage then escrow is opened 717.

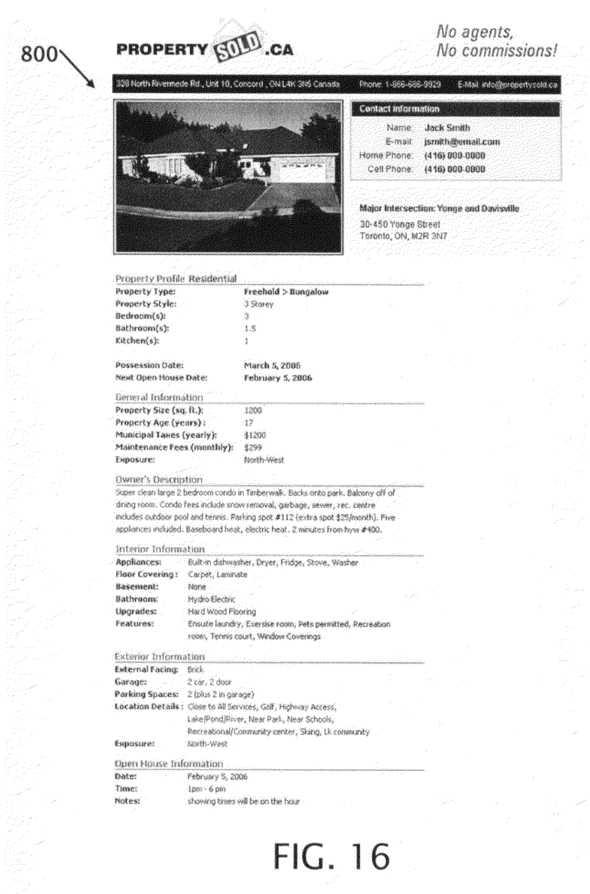

FIG. 16 shows a typical real estate listing page 800. The listing shows a picture of the property with the listing agents name and the particulars about the property that would be found in a MLS including but not limited to age of construction (years), asking price ($), building size (square feet), location (State, City, Street, School District, Zip code), lot size (acres), the number of bedrooms and bathrooms.

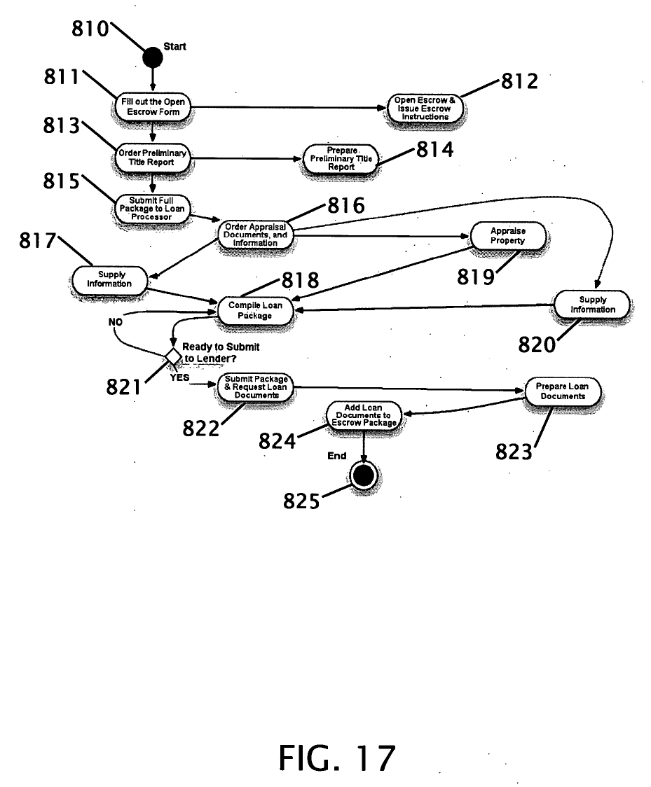

FIG. 17 shows a typical escrow process for a real estate transaction. A typical escrow continues from the process shown and described in FIG. 15 herein. Escrow starts 810 when an escrow form is filled out 811. At the opening of escrow, escrow instructions are issued 812 and a preliminary title report is ordered 813. The title report is prepared 814 and a full package is submitted to a loan processor 815. An appraisal is ordered with documents and information 816. The property is appraised 819 and information is supplied 817. The information and the appraisal is joined into a compiled package 818 where it is checked to determine if it is ready to send to the lender 821. If the pack age is not ready for the lender then it is returned. If the package is ready then the package is submitted and a request for loan documents is requested 822. Loan documents are prepared 823 and added to the escrow package 824. The process then ends 825.

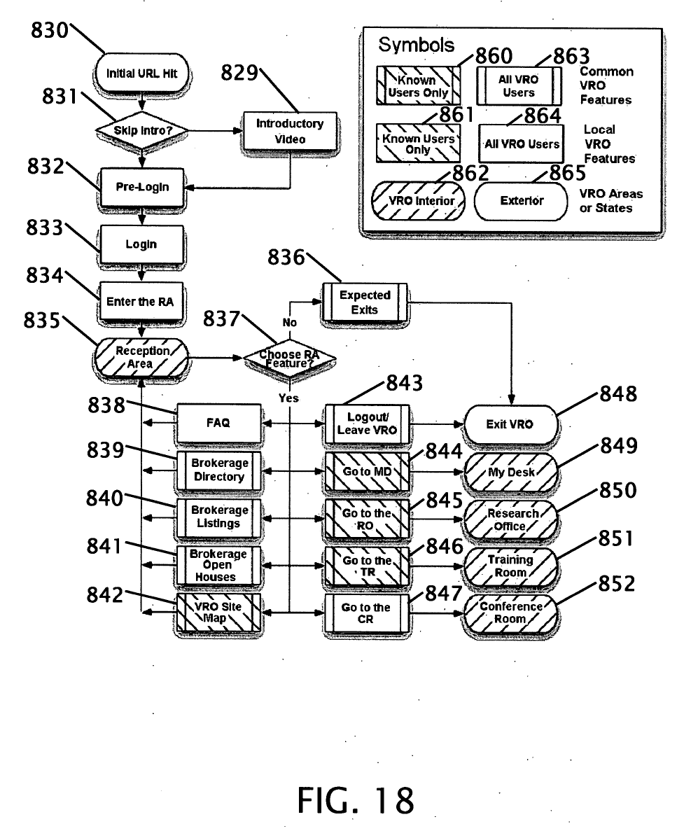

FIG. 18 shows a relationship of various features on the virtual real estate office. Upon an initial URL hit 830 a user has the option to skip the introduction 831 or view the introductory video 829. They will go though a pre-login 832 where they will login 833 and enter their RA 834 to enter the reception area 835. From the reception area 835 the user selects a RA feature 837. If the system detects an exit request 836 then the system will exit the virtual realty office 848.

A set of symbols are shown in this figure that shows where users with different status are authorized. Common virtual realty office (VRO) features are available to known users only 860, and all virtual realty office (VRO) users 863. Local virtual realty features are available to known users only 861 and all virtual realty office users 864. Virtual realty office (VRO) areas or states are available to virtual realty office interior 862 and exterior 865.

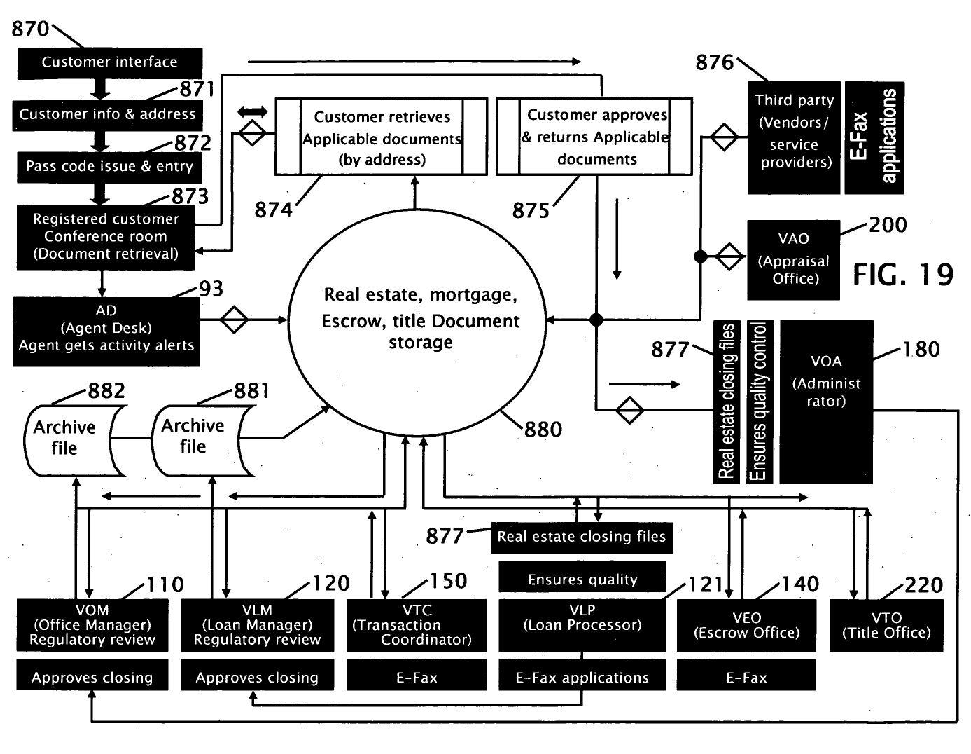

The feature that are available include but are not limited to frequently asked questions (FAQ) 838, log out of the virtual realty office (VRO), the brokerage directory 839, going to my desk 844, brokerage listings 840, go to the research office (RO) 845, brokerage open houses 841 got to the training room (TR) 846, virtual realty office (VRO) site map 842 and go to the CR 847. From the logout leave virtual realty office (VRO) a user can exit the virtual realty office (VRO) 848. From the go to my desk (MD) 844 the user has access to their desk 849. From the go to the research office (RO) 845 link a user is directed to the research office 850. From the go to the training room (TR) 846 link a user is directed to the training room 851. From the go to the conference room (CR) 847 a user is directed to the conference room. The connections and links between the different portions of the virtual realty office are controlled by a matrix of option and user access authorizations. A sample of one table that identifies links giving authorization is shown and described in FIG. 19.

FIG. 19 shows a flow chart of the saving viewing and retrieval of documents within the virtual realty office. When a customer begins the process of purchasing realty a file is opened. In the real world this file is created and maintained in a paper version. In the virtual realty office this file may be created with a combination of real (paper) documents and virtual documents or entirely with virtual documents. The virtual realty office has the advantage of keeping a copy of all the documents in a virtual environment where they can be transmitted or viewed anywhere with connection to the database. From the customer interface 870 a customer enters information that identifies them to the database 871. They will then enter a pass code to enter the database 872. The user then enters a conference room 873 where they have access to the documents they are authorized to view, alter or print. The realty agent receives notification that someone is accessing the file and a record is created that identifies the person that accessed the data with a date and time stamp 93. The documents are “checked out” in a similar manner that paper documents would be checked out 874. If an approval is required the user e-signs the documents, or approves the document 875 where it is returned to the files or is forwarded to another party to continue the possessing.

Third party vendors and or service providers 876 can be accessed from the virtual realty office. These third party service providers can provide extermination, virtual appraisal office (VAO) 200, construction, moving and inspection services. While several services that are related to or needed by the realty transaction are identified other services such as dry cleaning or restaurants are contemplated. These services can be ordered or verified with an E-Fax application or the like. A record of the order and any transaction is saved and viewable from the real estate, mortgage, Escrow, title document storage 880. The virtual office administrator (VOA) 180 has access to all the files in the database to ensure quality of the files and maintains them until the transaction closes 877. The virtual realty office software can check each document to verify accuracy of the information and identify discrepancies in the entered information where it identifies potential erroneous information. The virtual office administrator routs all transactions through the virtual office manager (VOM) 110 who approved the documents and authorizes them for placement into or back into storage 880 and to the closing of the transaction.

All the parties agencies, lenders that need access to the data regarding a specific transaction have access to the documents 880. Access is granted through passwords and authority levels that are identified by the agent(s). The parties that need access to add, or alter the stored documents include but are not limited to the virtual loan manager (VLM) 120, the virtual loan processor (VLP) 121, the virtual transaction coordinator (VTC) 150, the virtual escrow office (VEO) 140 and the virtual title officer (VTO) 220. The virtual title company has access to other documents that include but are not limited to ordering a profile, a farm package, recent recordings, N.O.D. lists, Title search, document requests, messenger requests, order CC&R's Manager profile, Rep profile and open a title order. After the realty transaction ends the files are transferred to a one or more archive file systems 881 and 882 where they can be retrieved in the case of loss or damage from any of the parties.

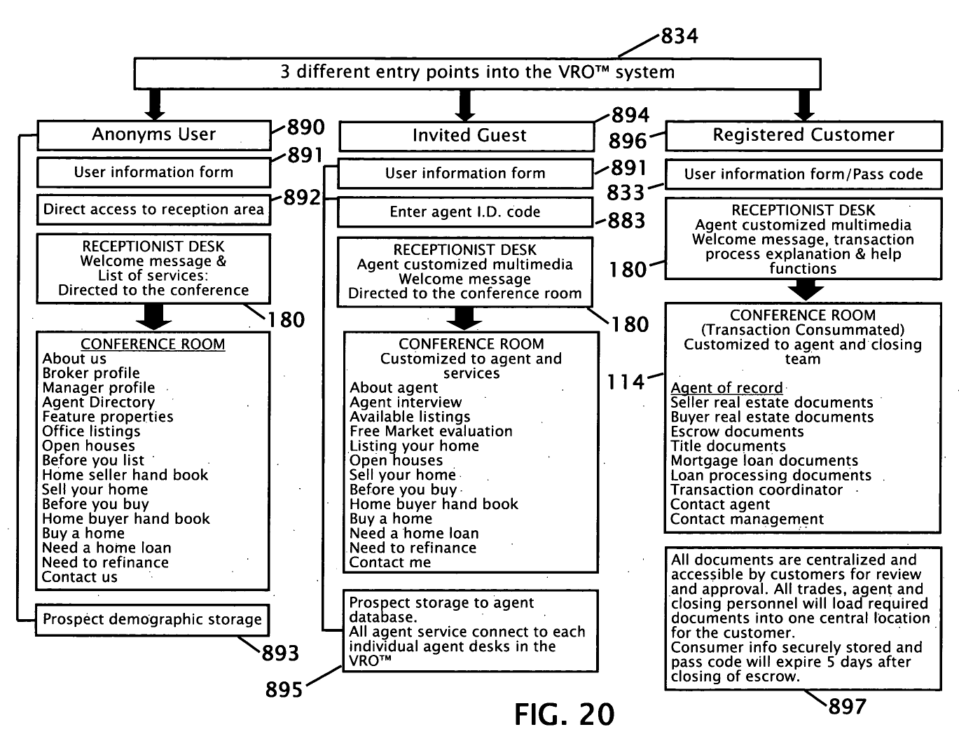

FIG. 20 shows three different types of users 834 of the virtual realty office and the access that is available for each user. In the left most column an anonymous user 890 enters the virtual realty office. In order for an anonymous user to gain access beyond the reception area of the virtual realty office the user must enter information into a form 891 that will grant them direct access to the reception area 892. From the reception desk they will have options to leave a message for someone, or be directed to a conference room. The reception desk will provide a list of services that are available to a known anonymous user. From the anonymous user may be granted access to a list of options including but not limited to information “About us”, a broker profile, manager profile, agent directory, feature properties, office listings, open houses, before you list, home seller hand book, selling your home, before you buy, home buyer hand book, buy a home, need a home loan and contacting the virtual realty office. The information from multiple anonymous people is entered in the user information form and a prospect demographic is stored 893.

In the middle column an invited guest 894 has a similar and different set of options available to them. They will enter a user information form 891 where they will identify them to the system 891 and enter an agent I.D. code 883 that will grant them access to their files and the files they are authorized to view. The reception desk 180 provides a similar and different set of options customized for the agent and services. It is contemplated that the options available to the invited guest include but are not limited to about agent, agent interview, available listings, free market evaluation, listing your home, sell your home, before you buy, home buyer hand book, buy a home loan, need a home loan, need to refinance and contact me. Information that is changed, altered or saved is stored in the agent database 895.

The right column contains information for a registered customer 896. A registered customer will first enter information that will identify them to the system 833 with a password or similar identifier. The reception desk 180 provides options that include but are not limited to an agent customized multimedia welcome message, transaction process explanation & help functions. The conference room 114 is customizable to the agent and the closing team. These options include but are not limited to agent of record, seller real estate documents, buyer real estate documents, escrow documents, title documents, mortgage loan documents, loan processing documents, communications with the transaction coordinator, contacting the agent and contacting the management. All documents 897 are are centralized and accessible by customers for review and approval. All trades, agent and closing personnel will load required documents into one central location for the customer. Consumer information is securely stored and pass code access to the information will expire a finite number of days after closing of escrow.

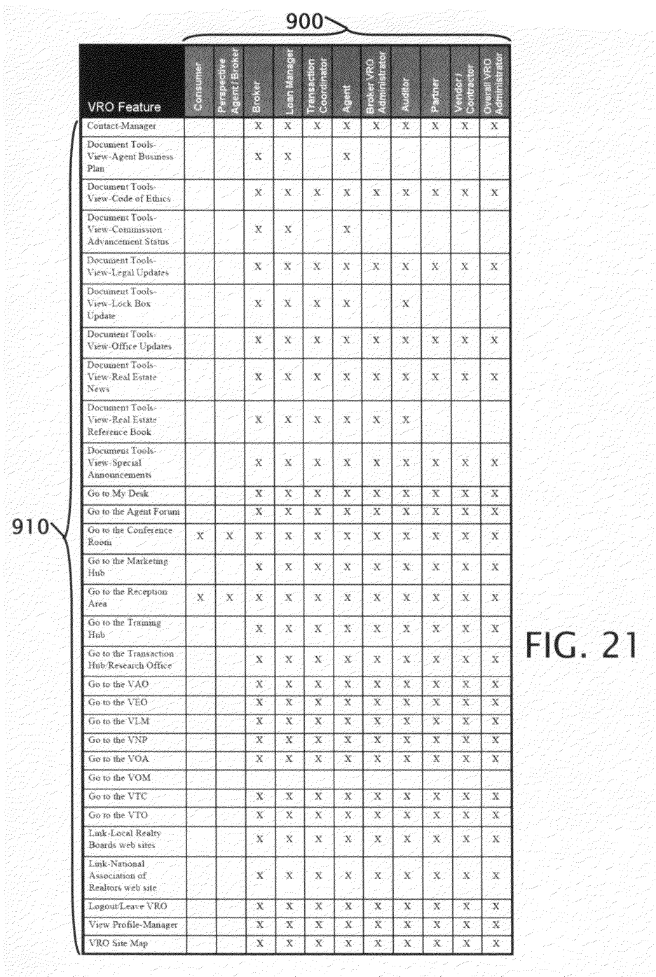

FIG. 21 shows a table of access authorization for users of the virtual real estate office. In this table series of different classifications of users is identified across the top of the table 900. A series of locations where a user can go is shown on the left side 910 of the table. The intersection of each user 900 and each link location 910 is designated with an “X” to identify that a user can make this selection or a blank box meaning the user does not have access to this particular area. While only one table is shown the process is similar for most other areas within the virtual realty office (VRO).

It is contemplated that a user can enter a panel to receive general information that includes static information on a number of topics, either provided by TDR as part of the VRO or by the brokerage. Examples of these features might include but not be limited to selling your home (presents a video/multimedia overview of the home selling process), buying a home (provides a video/multimedia overview of the home buying process), home mortgage information (provides an overview of the home loan process and may include current programs and interest rates), refinancing (provides an overview of the refinancing process), press clippings (provides access to recent articles about The Division Realty and/or the franchisee), about this brokerage (provides a general overview of the brokerage's mission, vision, place in the community, etc), brokerage office location/directions (provides a summary map of the brokerage office location with a link to Google Maps, Map Quest, or a similar direction-finding application), brokerage contact information (provides general contact information for the brokerage-main telephone number, main e-mail address, etc), about the brokerage (provides a general overview of offices mission, vision, place in the market, etc), and contact information (provides general contact information for software package, intended for potential Franchisees, Agents, Partners, Auditors, and Vendors/Contractors).

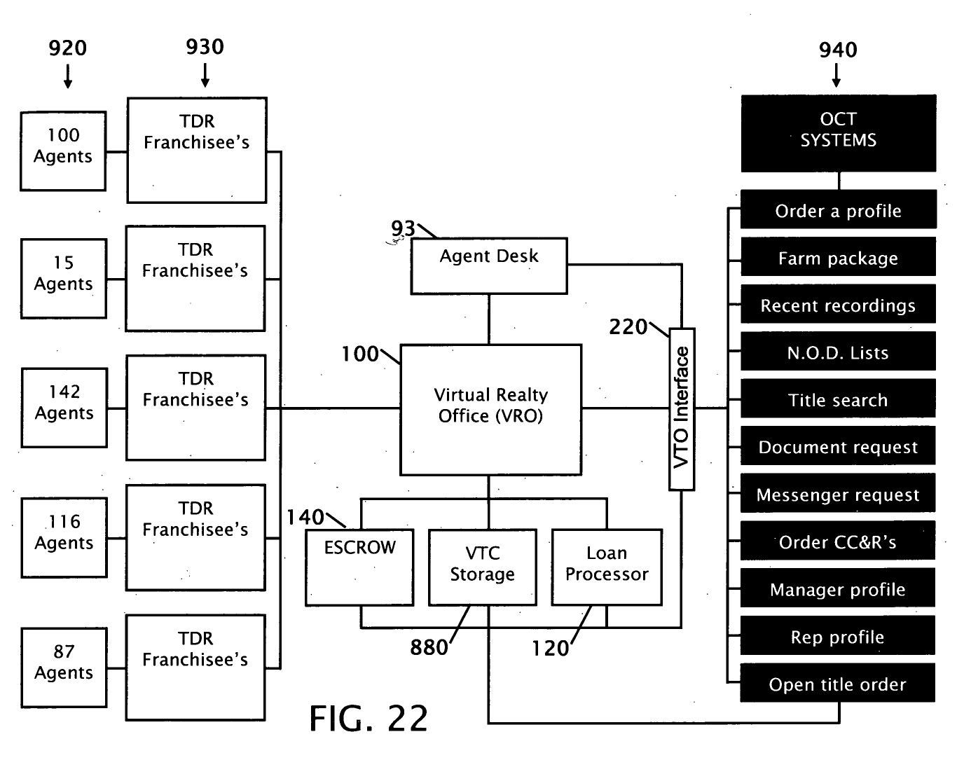

FIG. 22 shows a sample integration of the VTO in one contemplated embodiment. The system is set-up in a franchise type arrangement with the Virtual realty office VRO 100 being the central hub of all transactions. The system is established with one or more franchisee's 930. The franchisee's pay a periodic amount for access to the virtual realty office 100. Each franchisee has one or more realty agents that work for them 920. The number of realty agents 920 that are a part of each franchise is variable based upon the community the franchisee serves. In this figure there are five franchisees and the number of agents varies from 15 to 142 but there is no limit to the number of franchisees or the number of agents associated with each franchisee. All licensed franchisee's have equal access to the virtual realty office unless there are special features or functions where limiting access to some functions is desired. Below the virtual realty block 100 is the escrow 140, loan processing 120 and the data storage (VTC) 880. Each agent's desk 93 sits in a direct connection with the virtual realty office database 100. The OTC system 940 provides access to title documents for the virtual title office 220 where the title officer may need including but not limited to ordering a profile, a farm package, recent recordings, N.O.D. lists, Title search, document requests, messenger requests, order CC&R's Manager profile, Rep profile and open a title order.

Thus, specific embodiments of a Virtual Realty Office have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A virtual real estate office having links to services comprising:
a virtual real estate agent that links to a physical person that supervises realty transaction they are responsible for;
access through the virtual real estate office for searching, viewing and printing of realty that is available;
a virtual title company that manages the title search, preparation and delivery of the title for the realty transaction;
a virtual appraiser that connects to a virtual or physical real estate appraiser that provides an appraisal of realty;
a virtual escrow office that links to a virtual or physical escrow officer that manages the realty transaction;
a virtual loan manager that links to at least one lending institution for managing financial arrangement for the realty transaction;
a research library that includes a depository of forms that include leasing, rental, mortgage, real estate and legal documents;
a marketing hub for advertising the services of a real estate agent, and a real estate sales office;
a training hub for educating and training employees in the use of the virtual real estate office and real estate transactions;
a recruiting hub for receiving resumes and conducting virtual interviews and scheduling physical interviews;
a networking panel for connecting buyer or sellers to businesses and services.

2. The virtual real estate office according to claim 1 wherein the virtual real estate agent is one or a network of physical persons that communicate, network and interface with each other and with customers where the virtual real estate office is a portal of information and connection between the customer and the services available through the virtual real estate office.

3. The virtual real estate office according to claim 1 wherein the appraiser accesses the virtual real estate office to find similar properties for comparison to determine the appraised value of the realty.

4. The virtual real estate office according to claim 1 wherein the research library includes forms, procedures, legal documents, document storage, and a depository for prior transactions.

5. The virtual real estate office according to claim 1 wherein the training hub includes training, education, on line classes, links to classes within the area, insight from senior real estate agents and certificates of completion.

6. The virtual real estate office according to claim 1 wherein the recruiting hub provides for a conduit for potential new employees to view open positions, apply for the open positions and participate in a virtual or live interview by phone, person or web camera.

7. The virtual real estate office according to claim 1 wherein further includes a hub where a perspective buyer or seller can view the background of the available agents and can select an agent for further dealings.

8. The virtual real estate office according to claim 1 that further includes an auditing algorithm that verifies and checks for existing and potential problems or conflicts in the transaction.

9. The virtual real estate office according to claim 1 that further includes an information or frequently asked question area for current or potential clients to obtain answer to common questions without contacting a physical person by email, message or phone.

10. The virtual real estate office according to claim 1 that further includes links to service or contractors including, plumbers, carpenters, grocery stores, painter, repair people, banks and other community services.

11. A virtual realty office comprising:
a central data storage hub where all the documents associated with a real estate transaction is stored in the central data storage hub;
a seller stores images and a description of a property for sale in a unique file in the central data storage hub and are viewable at a distal location;
a buyer views the sellers stored images and creates a purchase offer where they virtually sign the offer for the property for sale and place the offer into the unique file on the central data storage hub;
the seller downloads or views the purchase offer and accepts, rejects or makes a counter offer and virtually signs the response that is placed into the unique file on the central data storage hub;
if an agreement is reached between the buyer and seller escrow is opened and escrow documents are populated into the unique file on the central data storage hub;
a title search is prepared and the title documents are placed into the unique file on the central data storage hub;
an appraisal is ordered and the appraisal documents are placed into the unique file on the central data storage hub;
loan documents are created and sent to at least one source for funding the real estate where the loan documents are placed into the unique file on the central data storage hub; and
each of the documents stored within the unique file on the central data storage hub are accessible by authorized people in the real estate transaction for a terminal that has access to the central data storage hub.

12. The virtual realty office according to claim 11 wherein a virtual real estate agent is one or more physical persons that communicate, network and interface with each other and with buyer or the seller.

13. The virtual realty office according to claim 11 wherein the appraisal is performed by an appraiser that has accesses the unique file in the central data storage hub where to find similar properties for comparison to determine the appraised value of the realty.

14. The virtual realty office according to claim 11 that further includes a research library includes forms, procedures, legal documents, document storage, and a depository for prior transactions.

15. The virtual realty office according to claim 11 that further includes a training hub that includes training, education, on line classes, links to classes within the area, insight from senior real estate agents and certificates of completion.

16. The virtual realty office according to claim 11 that further provides for a conduit for potential new employees to view open positions, apply for the open positions and participate in a virtual or live interview by phone, person or web camera.

17. The virtual realty office according to claim 12 that further includes a hub where a perspective buyer or seller can view the background of available real estate agents and can select an agent for further dealings.

18. The virtual realty office according to claim 11 that further includes an auditing algorithm that verifies and checks for existing and potential problems or conflicts in the unique file on the central data storage hub.

19. The virtual realty office according to claim 11 that further includes an information or frequently asked question area for current or potential clients to obtain answer to common questions without contacting a physical person by email, message or phone.

20. The virtual real estate office according to claim 1 that further includes links to service or contractors including, plumbers, carpenters, grocery stores, painter, repair people, banks and other community services.
